(19) United States
(12) Patent Application Publication
(10) Pub. No.: US 2009/0129083 A1
(43) Pub. Date: May 21, 2009

(54) LED UNIT AND OPTICAL SOURCE MODULE HAVING THE SAME

(75) Inventor: You Kun An, Gyeonggi-do (KR)

Correspondence Address: GREENBLUM & BERNSTEIN, P.L.C., 1950 ROLAND CLARKE PLACE, RESTON, VA, 20191, US

(73) Assignee: HYUNDAI MOBIS CO., LTD., Seoul (KR)

(21) Appl. No.: 12/059,035

(22) Filed: Mar. 31, 2008

(30) Foreign Application Priority Data
Nov. 21, 2007 (KR) 10-2007-0119240

(51) Int. Cl. F21V 13/04

(52) U.S. Cl. 362/243

(57) ABSTRACT

Disclosed are an LED unit, provided in a lighting apparatus, and an optical source module having the same. The LED unit includes a first LED array emitting a first irradiation light; and a second LED array lighted up separately from the first LED array or together with a portion of the first LED array and thus emitting a second irradiation light.

### BACKGROUND OF THE INVENTION

1. Field of the Invention

The present invention relates to an LED unit, and more particularly to an LED unit, provided in a lighting apparatus, and an optical source module having the same.

2. Description of the Related Art

In general, lighting apparatuses for stably obtaining a driver's field of vision even when the intensity of surrounding illumination is low during driving are provided in a vehicle. Among these lighting apparatuses, head lamps are divided into a high beam unit and a low beam unit according to the irradiation angle and the amount of light irradiated from the lamps. The operations of the high beam unit and the low beam unit are respectively controlled by the manipulation of a multi-functional switch provided at the side of a steering wheel.

Further, a fog lamp is a subsidiary lamp for obtaining the driver's field of vision in inclement weather, such as snow, rain, or fog. The fog lamp lights a place nearer than the head lamp, and irradiates light having a high transmissivity and a high irradiation angle, thus being used to check the existence of opposite vehicles or pedestrians.

Some countries in North America and Europe employ a daytime running light (DRL), which causes a head lamp to be turned on when a key switch is turned on when the engine of a vehicle is started up. Such a DRL is used to obtain a driver's field of vision when the field of vision is poor in the daytime due to fog, rain, yellow sand wind, or to rapidly transmit a driving speed and a driving direction to other drivers.

The above DRL is implemented by various methods, including a method, in which a separate DRL unit is connected to the outside a body control module (BCM) of a vehicle and is used with a head lamp or a fog lamp, or a method, in which a separate DRL device is provided. The method, in which the separate DRL unit is used with the head lamp or the fog lamp, requires the separate DRL unit, is complicated in configuration of a circuit, and causes a difficulty in mass production due to an internally built-in manipulation switch. Accordingly, the method, in which the separate DRL device is provided, was mainly used conventionally.

However, the above-described conventional lighting apparatus requires a DRL provided separately from a head lamp and a fog lamp, and thus additionally requires parts for manufacturing and installing the DRL and a manufacturing process thereof and requires a separate space for installing the DRL so as to achieve the function of the DRL in the lighting apparatus, thereby restricting the structure and design of the lighting apparatus and a vehicle having the lighting apparatus.

Further, costs and time taken to manufacture the lighting apparatus and the vehicle having the lighting apparatus are increased, and the total weight of the lighting apparatus and the vehicle having the lighting apparatus is increased. Thus, an improvement for solving the above problems has been required.

### SUMMARY OF THE INVENTION

Therefore, the present invention has been made in view of the above problems, and it is an object of the present invention to provide an LED unit having an improved structure, which achieves a DRL function without a DRL provided separately from a head lamp and a fog lamp, and an optical source module having the LED unit.

In accordance with one aspect of the present invention, the above and other objects can be accomplished by the provision of an LED unit comprising a first LED array emitting a first irradiation light; and a second LED array emitting a second irradiation light.

Preferably, the first LED array and the second LED array are separately lighted up.

Further, preferably, the LED unit further comprises a heat emission part for cooling the first LED array and the second LED array.

In accordance with another aspect of the present invention, there is provided an LED unit comprising a first LED array emitting a first irradiation light; and a second LED array lighted up together with a portion of the first LED array and thus emitting a second irradiation light.

Preferably, the first LED array includes a plurality of LED elements; and the second LED array includes a smaller number of LED elements than that of the first LED array.

Further, preferably, the second LED array is lighted up together with a portion of the first LED array, which is most adjacent to the second LED array.

Moreover, preferably, the LED unit further comprises a heat emission part for cooling the first LED array and the second LED array.

In accordance with yet another aspect of the present invention, there is provided an optical source module comprising an LED unit emitting a first irradiation light or a second irradiation light; a first reflection part reflecting the first irradiation light or the second irradiation light emitted from the LED unit; a light shade part shutting out a portion of the first irradiation light reflected by the first reflection part; a second reflection part reflecting the second irradiation light reflected by the first reflection part; and a lens part transmitting the first irradiation light, passed through the light shade part, or the second irradiation light, reflected by the second reflection part.

Preferably, the LED unit comprises a first LED array emitting the first irradiation light; and a second LED array emitting the second irradiation light.

Further, preferably, the first LED array and the second LED array are separately lighted up.

Moreover, preferably, the LED unit further comprises a heat emission part.

Preferably, the LED unit comprises a first LED array emitting the first irradiation light; and a second LED array lighted up together with a portion of the first LED array and thus emitting the second irradiation light.

Further, preferably, the first LED array includes a plurality of LED elements; and the second LED array includes a smaller number of that of the LED elements of the first LED array.

Moreover, preferably, the second LED array is lighted up together with a portion of the first LED array, which is most adjacent to the second LED array.

Preferably, the LED unit further comprises a heat emission part.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic longitudinal sectional view of an optical source module in accordance with one embodiment of the present invention;

FIG. 2 is a schematic perspective view of an LED unit shown in FIG. 1;

FIG. 3 is a schematic plan view of the LED unit shown in FIG. 1;

FIG. 4 is a schematic view illustrating an optical structure of the optical source module shown in FIG. 2;

FIG. 5 is a view illustrating a light distribution region by a first irradiation light;

FIG. 6 is a view illustrating a light distribution region by a second irradiation light;

FIG. 7 is a schematic plan view of an LED unit in accordance with another embodiment of the present invention; and

FIG. 8 is a view illustrating an operating relation of the LED unit shown in FIG. 7.

### DESCRIPTION OF THE PREFERRED EMBODIMENTS

Now, with reference to the annexed drawings, an LED unit and an optical source module having the same in accordance with one embodiment of the present invention will be described in detail. For convenience of description, an LED unit, provided in a lighting apparatus of a vehicle, and an optical source module having the same are taken as an example. Here, the thicknesses of lines or the sizes of the elements shown in the drawings may be exaggerated for clearness and convenience of description. Also, the terms used in the following description are terms defined taking into consideration the functions obtained in accordance with the present invention. The definitions of these terms should be determined based on the whole content of this specification because they may be changed in accordance with the option of a user or operator or a usual practice.

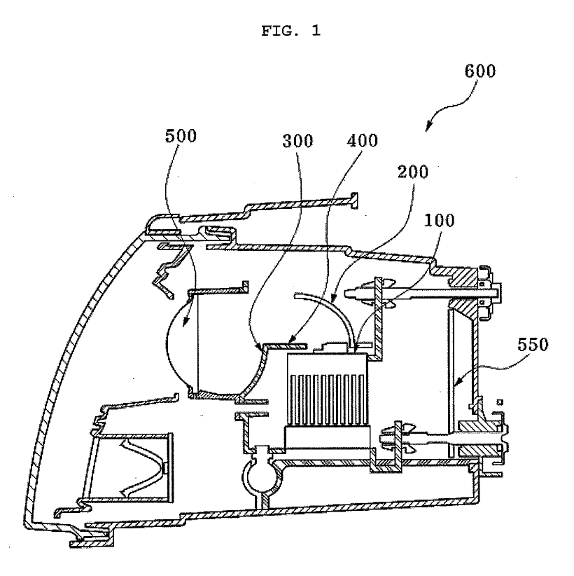

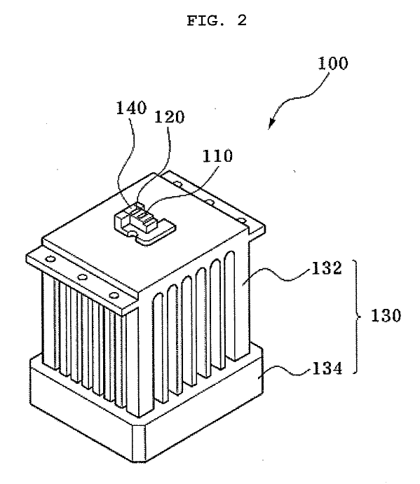

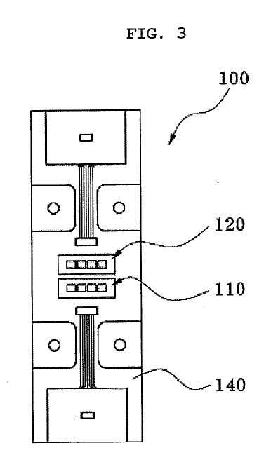

FIG. 1 is a schematic longitudinal sectional view of an optical source module in accordance with one embodiment of the present invention, FIG. 2 is a schematic perspective view of an LED unit shown in FIG. 1, and FIG. 3 is a schematic plan view of the LED unit shown in FIG. 1.

First, with reference to FIG. 1, an optical source module 600 in accordance with one embodiment of the present invention includes an LED unit 100, a first reflection part 200, a light shade part 300, a second reflection part 400, and a lens part 500.

The LED unit 100, as shown in FIGS. 2 and 3, includes a first LED array 110, a second LED array 120, and a heat emission part 130.

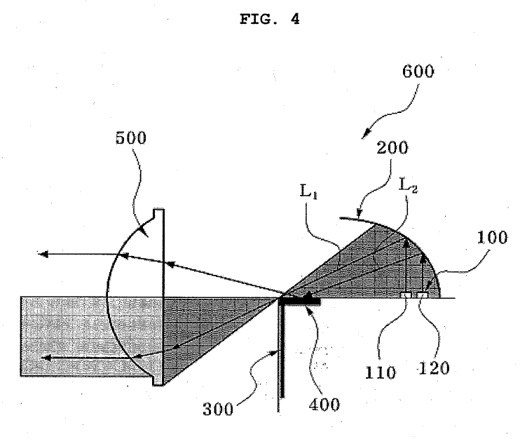

The first LED array 110 includes one or plural LED elements for emitting a first irradiation light L₁ (with reference to FIG. 4), and is mounted on a chip part 140. Here, the chip part 140 includes a plurality chips (numeral is omitted) and a circuit connected to the first and second LED arrays 110 and 120. Those skilled in the art appreciate the chip part 140, and a detailed description of the chip part 140 will thus be omitted.

The second LED array 120 includes one or plural LED elements for emitting a second irradiation light L₂ (with reference to FIG. 4), and is mounted on the chip part 140. The first and second LED arrays 110 and 120 are separately provided, and are separately lighted up.

The heat emission part 130 serves to cool heat generated from the first and second LED arrays 110 and 120 and the chip part 140 due to the emission of light from the first and second LED arrays 110 and 120.

The heat emission part 130 includes a heat sink 132 including a plurality of heat emission pins (numeral is omitted) provided on the lower surface of the chip part 140, and a fan 134 provided on the lower surface of the heat sink 132 for cooling heat emitted from the heat sink 132, thereby emitting and cooling the heat generated from the first and second LED arrays 110 and 120 and the chip part 140.

Since the above LED unit 100 includes the two LED arrays 110 and 120, which are provided on the single chip part 140, it is not necessary to dispose the heat emission part 130 on each of the two LED arrays 110 and 120 but the heat emission part 130 is disposed on one LED unit 100, i.e., on the two LED arrays 110 and 120. Thus, it is possible to reduce a space and costs for the components of the heat emission part 130, such as the heat sink 132 and the fan 134.

The first reflection part 200 reflects the first irradiation light L₁ or the second irradiation light L₂ emitted from the LED unit 100. For this reason, a reflection surface (numeral is omitted) is formed on the surface of the first reflection part 200 opposite to the LED unit 100. A spheroidal surface, an oval-parabola mixed surface, or a free-form surface having a high degree of freedom by the manipulation of a curved surface is used as the reflection surface.

The light shade part 300 shuts out a portion of the first irradiation light L₁ reflected by the first reflection part 200. Most of the first irradiation light L₁ emitted from the first LED array 110 is reflected by the reflection surface of the first reflection part 200. A portion of the reflected first irradiation light L₁ is shut out by the light shade part 300, and the other portion of the first irradiation light L₁, which is not shut out by the light shade part 300 and travels forward, passes through the lens part 500, and is irradiated to the outside of the optical source module 600. Further, a cut-off line, which determines a boundary between light and darkness of a light distribution pattern, is formed by the upper edge of the light shade part 300.

The second reflection part 400 reflects the second irradiation light L₂ reflected by the first reflection part 100. The second reflection part 400 is formed in the shape of a flat reflecting mirror, which is orthogonal to the optical axis of the second LED array 120. In the same manner as the first irradiation light L₁, most of the second irradiation light L₂ emitted from the second LED array 120 is reflected by the reflection surface of the first reflection part 200. The reflected second irradiation light L₂ is reflected again by the second reflection part 400. Then, the second irradiation light L₂ is widely distributed, passes through the lens part 500, and is irradiated to the outside of the optical source module 600.

The lens part 500 transmits the first irradiation light L₁, passed through the light shade part 300, or the second irradiation light L₂, reflected by the second reflection part 400. The lens part 500 includes a transparent lens.

Here, non-described reference numeral 550 represents a driving module for driving the LED unit 100.

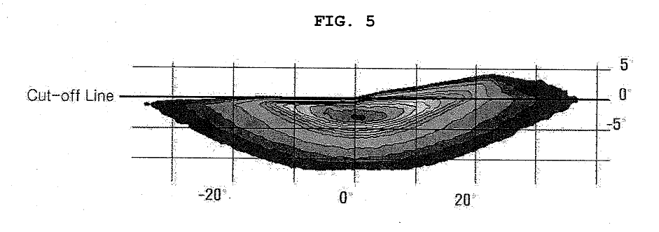

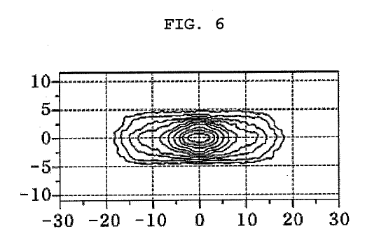

FIG. 4 is a schematic view illustrating an optical structure of the optical source module shown in FIG. 2, FIG. 5 is a view illustrating a light distribution region by the first irradiation light, and FIG. 6 is a view illustrating a light distribution region by the second irradiation light.

Hereinafter, with reference to FIGS. 4 to 6, an operating relation and optical structure of the optical source module in accordance with one embodiment of the present invention will be described.

As an example of the optical source module of this embodiment, an optical source module, which is provided in a lighting apparatus of a vehicle, and more specifically, a head lamp or a fog lamp of a vehicle, is taken.

First, with reference to FIG. 4, the first LED array 110 and the second LED array 120 of the LED unit 100 are respectively lighted up by the driving module 550 (with reference to FIG. 1). The driving module 550 is electrically connected to the LED unit 100, and serves to light up the first LED array 110 when a signal for lighting up the first LED array 110 is transmitted to the driving module 550, and light up the second LED array 120 when a signal for lighting up the second LED array 120 is transmitted to the driving module 550.

Here, the signals are transmitted from corresponding switches or sensors in a driver's seat in a vehicle. Those skilled in the art appreciate a method for transmitting the signals to the driving module 550, and a detailed description thereof will thus be omitted

When the first LED array 110 is lighted up by the driving unit 550, the first LED array 110 emits the first irradiation light L₁. The emitted first irradiation light L₁ is reflected by the first reflection part 200. A portion of the reflected first irradiation light L₁ is shut out by the light shade part 300, and the other portion of the reflected first irradiation light L₁, which is not shut out by the light shade part 300 and travels forward, passes through the lens part 500 and is irradiated to the outside of the optical source module 600. This first irradiation light L₁ is distributed downward, while forming the cut-off line, which determines the boundary between light and darkness of the light distribution pattern, as shown in FIG. 5, by the upper edge of the light shade part 300.

The above first irradiation light L₁ corresponds to light emitted from the conventional fog lamp. Further, in the case that the intensity of illumination of the first irradiation light L₁ is varied, the first irradiation light L₁ corresponds to light emitted from a low beam unit of the conventional head lamp (not shown). That is, the optical source module 600, in which the first LED array 110 is lighted up, performs a function corresponding to the conventional fog lamp or the low beam unit of the conventional head lamp.

On the other hand, when the second LED array 120 is lighted up by the driving unit 550, the second LED array 120 emits the second irradiation light L₂. The emitted second irradiation light L₂ is reflected by the first reflection part 200, in the same manner as the first irradiation light L₁. The second irradiation light L₂ reflected by the first reflection part 200 is reflected again by the second reflection part 400. During the above process, the second irradiation light L₂ is widely diffused, as shown in FIG. 6, and thus has an intensity of illumination lower than that of the first irradiation light L₁. Then, the second irradiation light L₂ longitudinally widely passes through the lens part 500, and is distributed to the outside of the optical source module 600. This second irradiation light L₂ corresponds to light emitted from the conventional DRL. That is, the optical source module 600, in which the second LED array 120 is lighted up, performs a function corresponding to the conventional DRL.

In accordance with the optical source module 600 in accordance with one embodiment of the present invention, as described above, one LED unit 100 includes two LED arrays 110 and 120, and thus a single optical source module 600 may achieve the functions of the low beam unit of the head lamp and the DRL, or the functions of the fog lamp and the DRL, simultaneously. That is, it is possible to achieve a DRL function on a lighting apparatus of a vehicle without having a separately DRL.

Although not described above, in the case that one LED unit 100 includes three or more LED arrays, a single optical source module 600 may achieve functions of three or more units simultaneously.

As described above, the optical source module 600 of this embodiment can achieve a DRL function without having a separate DRL, thereby not requiring a space for mounting the DRL and reducing the number of parts required to manufacture a lighting apparatus of a vehicle and the number of steps of a process for manufacturing the lighting apparatus of the vehicle.

Accordingly, the optical source module 600 in accordance with one embodiment of the present invention increases a degree of freedom of the structure and design of a lighting apparatus and a vehicle having the lighting apparatus, and reduces overall costs and time taken to manufacture the lighting apparatus and the vehicle having the lighting apparatus and overall weights of the lighting apparatus and the vehicle having the lighting apparatus.

The above optical source module 600 is merely one embodiment of the present invention, and thus many other embodiments are possible.

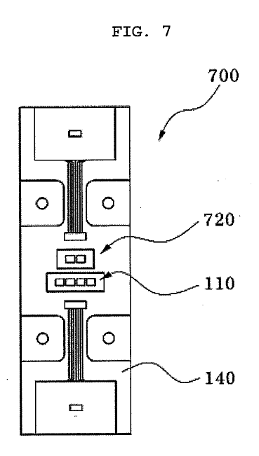

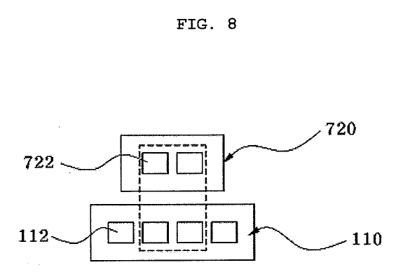

FIG. 7 is a schematic plan view of an LED unit in accordance with another embodiment of the present invention, and FIG. 8 is a view illustrating an operating relation of the LED unit shown in FIG. 7.

Hereinafter, with reference to FIGS. 7 and 8, an LED unit provided in an optical source module in accordance with another embodiment of the present invention will be described in detail.

In the drawings, the same elements, which are denoted by the same reference numerals, has the same functions, and a detailed description thereof will thus be omitted because it is considered to be unnecessary.

An LED unit 700 in accordance with another embodiment of the present invention, as shown in FIGS. 7 and 8, includes a first LED array 110 and a second LED array 720, which are disposed in parallel. Further, the second LED array 720 includes a smaller number of LED elements 722 than that of the first LED array 110. For example, in the case that the first LED array 110 includes four LED elements 112, the second LED array 720 includes two LED elements 722.

In the LED unit 700, the first LED array 110 is lighted up separately from the second LED array 720, and emits a first irradiation light L₁ (with reference to FIG. 4). When the second LED array 720 is lighted up in order to emit a second irradiation light L₂ (with reference to FIG. 4), a portion of the first LED array 110, and more particularly, two LED elements 112 of the four LED elements 112 of the first LED array 110, which are most adjacent to the LED elements 722 of the second LED array 720, are lighted up concurrently.

Accordingly, the LED unit 700 of this embodiment includes a smaller number of the LED elements 112 and 722, and thus achieves the functions of the low beam unit of the head lamp and the DRL, or the functions of the fog lamp and the DRL, simultaneously only with a single optical source module, thereby reducing manufacturing costs.

Further, the second irradiation light L₂ is a light having the function of the DRL, and this light is widely diffused and thus has a low intensity of illumination. The second irradiation light L₂ of the LED unit 700 of this embodiment is emitted from the LED elements 112 and 722, which are disposed in two lines in parallel, and is widely diffused and thus has a low intensity of illumination.

Although this embodiment describes the first LED array 110 including the four LED elements 112 and the second LED array 720 including the two LED elements 722, the present invention is not limited thereto.

As apparent from the above description, the present invention provides an LED unit, which includes two or more LED arrays so as to achieve a DRL function without a DRL provided separately, and an optical source module having the LED unit, thereby not requiring a separate space for mounting the DRL and reducing the number of parts required to manufacture a lighting apparatus of a vehicle and the number of steps of a process for manufacturing the lighting apparatus of the vehicle.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Further, although the embodiments of the present invention have described an LED unit, provided in a lighting apparatus of a vehicle, and an optical source module having the LED unit, and the description thereof has been made only for a better understanding of the present invention, and the present invention may be applied to other lighting apparatuses than the lighting apparatus of the vehicle. Accordingly, those skilled in the art will appreciate that various modifications, additions, and substitutions to the specific elements are possible, without departing from the scope and spirit of the invention as disclosed in the accompanying claims.

What is claimed is:

1. An LED unit comprising:
a first LED array emitting a first irradiation light; and
a second LED array emitting a second irradiation light.

2. The LED unit according to claim 1, wherein the first LED array and the second LED array are separately lighted up.

3. The LED unit according to claim 1, further comprising a heat emission part for cooling the first LED array and the second LED array.

4. An LED unit comprising:
a first LED array emitting a first irradiation light; and
a second LED array lighted up together with a portion of the first LED array and thus emitting a second irradiation light.

5. The LED unit according to claim 4, wherein:
the first LED array includes a plurality of LED elements; and
the second LED array includes a smaller number of LED elements than that of the first LED array.

6. The LED unit according to claim 4, wherein the second LED array is lighted up together with a portion of the first LED array, which is most adjacent to the second LED array.

7. The LED unit according to claim 4, further comprising a heat emission part for cooling the first LED array and the second LED array.

8. An optical source module comprising:
an LED unit emitting a first irradiation light or a second irradiation light;
a first reflection part reflecting the first irradiation light or the second irradiation light emitted from the LED unit;
a light shade part shutting out a portion of the first irradiation light reflected by the first reflection part;
a second reflection part reflecting the second irradiation light reflected by the first reflection part; and
a lens part transmitting the first irradiation light, passed through the light shade part, or the second irradiation light, reflected by the second reflection part.

9. The optical source module according to claim 8, wherein the LED unit comprises:
a first LED array emitting the first irradiation light; and
a second LED array emitting the second irradiation light.

10. The optical source module according to claim 9, wherein the first LED array and the second LED array are separately lighted up.

11. The optical source module according to claim 9, wherein the LED unit further comprises a heat emission part.

12. The optical source module according to claim 8, wherein the LED unit comprises:
a first LED array emitting the first irradiation light; and
a second LED array lighted up together with a portion of the first LED array and thus emitting the second irradiation light.

13. The optical source module according to claim 12, wherein:
the first LED array includes a plurality of LED elements; and
the second LED array includes a smaller number of LED elements than that of the first LED array.

14. The optical source module according to claim 12, wherein the second LED array is lighted up together with a portion of the first LED array, which is most adjacent to the second LED array.

15. The optical source module according to claim 12, wherein the LED unit further comprises a heat emission part.
